(19) United States
(12) Patent Application Publication
(10) Pub. No.: US 2021/0189169 A1
(43) Pub. Date: Jun. 24, 2021

(54) COATING COMPOSITIONS FOR IMPROVING APPEARANCE OF A MONO-COLOR WHITE PAINT AND ARTICLES COATED THEREWITH

(71) Applicant: PPG Coatings (Tianjin) Co., Ltd., Tianjin (CN)

(72) Inventors: Weijie Si, Tianjin (CN); Nan Lv, Tianjin (CN); Jinqiang Wang, Tianjin (CN)

(73) Assignee: PPG Coatings (Tianjin) Co., Ltd., Tianjin (CN)

(21) Appl. No.: 16/605,970

(22) PCT Filed: Apr. 17, 2018
(86) PCT No.: PCT/CN2018/083320

§ 371 Date: Oct. 17, 2019

(30) Foreign Application Priority Data
Apr. 17, 2017 (CN) 201710249787.9

(51) Int. Cl. C09D 167/02

(52) U.S. Cl. CPC C09D 167/02

(57) ABSTRACT

A coating composition comprises 10-20 wt % of polyester resin, 2-8 wt % of amino resin, and 0-6 wt % of acrylic resin, based on the total weigh of the coating composition. A substrate coated with the coating composition is also provided.

### FIELD OF INVENTION

The present invention relates to a coating composition for improving the appearance of a mono-color white paint of automotive parts (for example, bumper, spoiler, and door handle etc.) and articles coated with the same.

### BACKGROUND OF THE INVENTION

Currently, main body of automotives presents a variety of colors, in which the white color can account for 50% or greater among all colors. Primers for coating bumpers are substantially in black. It is required to apply a film having a thickness of 30-40 micrometers to achieve a complete masking effect when using a mono-color white paint to cover a black primer. However, with a high film thickness, the white paint may encounter conditions such as poor levelling and visual appearance and may also have issues like loss of gloss, poor recoating adhesion, bad humidity and weather resistance. In order to improve the orange peel appearance and whole properties of the mono-color white paint, the present inventors specifically select a resin system, a pigment, an additive and a solvent to create a mono-color white paint system having superior appearance suitable for use in colinear PP and ABS.

### SUMMARY OF THE INVENTION

The present invention provides a coating composition comprising 10-20 wt % of a polyester resin, 2-8 wt % of an amino resin, and 0-6 wt % of an acrylic resin, based on the total weight of the coating composition.

The present invention further provides a coated substrate, comprising a substrate and a coating composition deposited on at least a portion of the substrate, wherein the coating composition comprises 10-20 wt % of a polyester resin, 2-8 wt % of an amino resin, and 0-6 wt % of an acrylic resin, based on the total weigh of the coating composition.

### DESCRIPTION OF THE INVENTION

Other than in any operating examples, or where otherwise indicated, all numbers expressing, for example, quantities of ingredients used in the specification and claims, are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used herein, the weight average molecular weight (MW) of a polymer is determined by a gel permeation chromatography using an appropriate standard such as a polystyrene standard.

As used herein, the term “acid value” (or “neutralization number” or “acid number” or “acidity”) is the mass of potassium hydroxide (KOH) in milligrams that is required to neutralize free acid in one gram of sample, expressed in an unit of mg KOH/g.

As used herein, the term “hydroxyl value” is the mass of potassium hydroxide (KOH) in milligrams that is equivalent to hydroxyl groups in one gram of sample, expressed in an unit of mg KOH/g.

The primer for coating automotive bumpers, spoilers, door handles is mainly in black. It is typically required to apply a film having a thickness of 30-40 micrometers so as to completely masking a black primer when using a mono-color white paint to cover the black primer. However, with a high film thickness, the white paint may encounter conditions such as poor levelling and visual appearance and may also have issues like loss of gloss, poor recoating adhesion, bad humidity and weather resistance. The present invention provides a coating composition directed to improving the orange peel appearance of a mono-color white paint as well as the system properties as a whole. The coating composition comprises 10-20 wt % of a polyester resin, 2-8 wt % of an amino resin, and 0-6 wt % of an acrylic resin, based on the total weigh of the coating composition.

The polyester resin suitable for use in the present coating composition may be prepared by at least one polyacid and at least one polyol under appropriate conditions. Preferably, the polyester resin has a hydroxyl value from 50 to 100 mgKOH/g, an acid value from 0 to 5 mgKOH/g, and a weight average molecular weight (Mw) from 3000 to 5000. The polyester resin has excellent gloss, flexibility and rheological behavior and thus can improve the appearance of the coating and enhance the leveling property of the system. Suitable polyester resins may be commercially available, including without limitation the polyester resin from NUPLEX RESINS under the trade name of Setal 90173 SS-50.

The amino resin suitable for use in the present coating composition can be any amino resins known in the field of coatings, preferably melamine-formaldehyde resins. The amino resin can improve the gloss loss resistance. Suitable amino resins may be commercially available, including without limitation the amino resin from PPG USA under the trade name of FM-003 MELAMINE RESIN.

The acrylic resin used in the present invention is preferably hydroxy-functional acrylic polymers. Subitable hydroxy-containing acrylic polymers can be prepared by polymerable ethylenically-unsaturated monomers, and can be copolymers of (meth)acrylic and/or alkyl (meth)acrylate with one or more other polymerable ethylenically-unsaturated monomers which comprise for example alkyl (meth)acrylate, including methyl (meth)acrylate, ethyl (meth)acrylate, butyl (meth)acrylate, and 2-ethyl hexyl acrylate; ethyl vinyl aromatic compounds, such as styrene, α-methyl styrene, and Vinyl toluene, and the like. As used herein, the term “(meth)acrylate” and the like is intended to comprise both acrylate and (meth)acrylate.

Preferably, the acrylic resin has a a glass transition temperature (Tg) from 40 to 50° C., a hydroxyl value from 10 to 40 mgKOH/g, and a weight average molecular weight (Mw) from 20000 to 30000. Such acrylic resin can impart the coating system wetting disperability and aging resistance. The amount of the acrylic resin present in the coating composition will not be more than 6 wt %. When the amount of the acrylic resin is more than 6 wt %, the resulting coating behaves badly in loss of gloss, recoating adhesion, and humidity resistance, which can be observed by the comparative examples in the Example Section. Commercially available acrylic resins include but are not limited to 16-DLW-087 ACRYLIC RESIN from PPG USA.

The coating composition of the present invention further comprises about 20-40 wt % of a titanium dioxide pigment based on the total weight of the coating composition. The present invention is a system having a high solid content and a high pigment/binder ratio, due to the fact that the primer to which the present coating composition will be applied is a black paint and a high content of pigments with a low content of resin components is necessary to ensure the white topcoat could completely mask the black primer. The acrylic resin used in the coating composition is a grinding resin for the titanium dioxide pigment, with which the titanium dioxide could be grinded to generate a white paste for use in the mono-color white paint. The resulting coating composition has significant advantages in aspects such as storage stabilility, gloss loss resistance, recoatability, humidity resistance, especially in orange peel appearance.

The coating composition further comprises a solvent, which may comprise any appropriate solvents able to use together with other components of the present invention. Appropriate solvents would be obvious to persons skilled in the art upon reading the present specification. Examples of appropriate solvents include but are not limited to toluene or xylene, n-butanol or isopropanol, butyl acetate or ethylene glycol butyl ether acetate, acetone or methyl n-amyl ketone, or any mixture thereof. The solvent may be present in the coating composition of the present invention in an amount of 30-50 wt %, based on the weight of the composition.

The additive portions of the coating composition according to the present invention may further comprise other adjuvant components selected from one or more of a levelling agent, a cellulose acetate butyrate solution, a wetting dispersant, an UV absorbant, a resistivity regulator, as well as any additive known in the art that may be used in the present invention. These adjuvant components when present are in an amount of at most 4 wt % based on the weight of the coating composition.

In another aspect, the present invention provides a coated substrate, comprising a substrate and a coating composition deposited on at least a portion of the substrate. The substrate that can be coated with the present coating composition may be any suitable substrate, including but not limited to metal or plastic substrates. Preferably, the substrate comprise polypropylene (PP), polycarbonate (PC), and acrylonitrile-butadiene-styrene copolymer (ABS) substrate. For example, the substrate can be the PP or PC+ABS portions of exterior parts of the automotives. In particular, the substrate may be automotive bumpers, spoilers, and door handles.

The present coating composition is generally prepared according to the following procedures: selecting an appropriate grinding machine, grinding titanium dioxide with the acrylic resin to generate a while paste, adding in order the white paste, the polyester resin, amino resin and acrylic resin to a main tank with stirring, charging sequentially various solvents and additives into a premixing tank with stirring until the additives are completely dispersed to produce a premix, transferring the premix that has passed test to the maim tank, sampling the mixture after stirring for an appropriate period, testing and adjusting performance in the range as required, and storing qualified products for next use.

Applying the present coating composition can be carried out using the procedures commonly known by persons skilled in the art. Typically, the coating composition will be adjusted to a viscosity for spraying using a diluent/diluents. After coating a substrate with a primer, the coating composition will be sprayed to a desirable film thickness by using a Binks spraying gun set at a predetermined pressure followed by applying a varnish. The resulting paint film is flash-dried for an appropriate period, and then placed into an oven at 80-90° C. for baking 30-40 minutes. The thickness of the paint film is measured in the range of 30-40 μm. It is desirable to achieve a paint film having qualified orange peel without decifiencies including gloss loss, sagging, blistering, pinhole, impurity, adhesion and recoating adhesion.

### EXAMPLE

The following examples are provided to further illustrate the invention, which should not be considered as limiting the invention to the details as described therein. All parts and percentages in the examples and throughout the description are by weight unless otherwise indicated.

Preparation of the Present Coating Composition

The present coating compositions will be prepared based on the weight parts as shown in Table 1 according to the procedures as described above.

TABLE 1
Composition of the coating composition

| | | Comparative | Comparative |
|---|---|---|---|
| | Example 1 | Example 1 | Example 2 |
| Titanium dioxide ¹ | 30.8 | 32.7 | 31.4 |
| Polyester resin ² | 16.4 | 8.6 | 14.3 |
| Amino resion³ | 5.6 | 6.8 | 0.0 |
| Acrylic resin⁴ | 5.8 | 8.5 | 5.1 |
| Solvent⁵ | 40.0 | 42.3 | 46.9 |
| Leveling agent⁶ | 0.03 | 0.03 | 0.02 |
| UV absorbant⁷ | 0.2 | 0.2 | 0.3 |
| CAB solution⁸ | 1.1 | 0.8 | 1.9 |
| Resistivity regulator⁹ | 0.04 | 0.02 | 0.03 |
| Wetting dispersant¹⁰ | 0.03 | 0.05 | 0.05 |

¹ Titanium dioxide, available from PPG TIANJIN;
² Polyester resin solution, available from NUPLEX RESINS;
³Melamine resin, available from PPG USA;
⁴Acrylic resin, available from PPG USA;
⁵Mixture of xylene, n-butanol, butyl acetate, propylene glycol methyl ether acetate, and methyl n-amyl ketone;
⁶Leveling additive, available from Dow Chemical, PA-56 and Disparlon LHP-91;
⁷EVERSORB 74, available from EVERLIGHT CHEMICAL;
⁸CAB Solution, available from EASTMAN CHEMICAL;
⁹BYK-ES 80, available from BYK CHEMICAL;
¹⁰Wetting and dispersing agent, available from BYK CHEMICAL.

Example 1 and Comparative Examples 1-2 are applied to a PP substrate according to the procedures as described above and the resulting coatings are tested for the following performance. Results are shown in Tables 2-6 below.
1. Orange Peel Appearance Test

Sample treatment: a sample plate is prepared by applying a basecoat and matching primer and varnish (primer: PPG MPP4100DGTJ; varnish: PPG TKU2000CCN-YF) to a PP substrate. The sample plate is immediately baked in an oven at 85° C. and taken out after 30 minutes. After complete cooling, the sample plate is tested for performance according to the following procedures.

A Micro-wave-scan orange peel meter is used to measure data including orange peel R value, long wave Lw, short wave Sw, distinctness of image DOI to evaluate orange peel according to GMW 15777-2011. The orange peel meter will emit a laser source when scanning on the surface of the color plate and a probe on the other end collects reflection light. Optical profile will be divided into long wave and short wave by a digital filter and the orange peel is evaluated based on the long wave and short wave. Orange peel rating as measured by the orange peel meter is characterized by R and is directly read on the orange peel meter.

It can be seen from results shown in Table 2 that the paint film prepared by the invention Example's coating has an orange peel appearance more than one level higher than those prepared by Comparative examples 1-2.

TABLE 2
Orange Peel Testing Results

| | Orange peel | Long wave, | Short wave, | Distinctness of |
|---|---|---|---|---|
| | R value | Lw | Sw | Image, DOI |
| Example 1 | 7.5 | 6.6 | 4.5 | 93.2 |
| Comparative | 6.0 | 14.5 | 16.0 | 91.7 |
| Example 1 | | | | |
| Comparative | 6.5 | 11.6 | 12.3 | 92.6 |
| Example 2 | | | | |

2. Gloss Loss Resistance Test

High-gloss coatings are prone to loss of gloss, and vague figures on the surface of the paint film would negatively affect the quality of the film. Gloss loss resistance is tested by the following procedure: applying a primer (PPG MPP4100DGTJ) matching a color paint to a PP substrate followed by applying the color paint, applying a varnish (TKU2000CCN-YF) in 1 min after flash-drying the color paint, baking the substrate in an oven at 85° C., taking it out after 30 minutes, and visually inspecting if gloss loss is present after complete cooling.

It can be seen from results shown in Table 3 that the paint film prepared by the invention Example's coating has gloss loss resistance significantly higher than those prepared by Comparative examples 1-2.

TABLE 3
Gloss Loss Resistance Testing

| | Evaluation of gloss loss | Distinctness of | |
|---|---|---|---|
| | via visual inspection | Image, DOI | Gloss |
| Example 1 | No gloss loss | 93.2 | 91.2 |
| Comparative | Slight gloss loss | 84.5 | 86.3 |
| Example 1 | | | |
| Comparative | Significant gloss loss | 87.4 | 89.6 |
| Example 2 | | | |

3. Recoatability Resistance Test

First pass yield for a bumper painting line is about 80-90% and unqualified products need to be polished and then reprocessed. White paints after being reprocessed are prone to having problems like paint-peeling and poor adhesion due to high film thickness. The following procedure is used to examine recoating adhesion.

Sample treatment: a sample plate is prepared by applying a basecoat (YF-SGM9753(YT)) and matching primer and varnish (primer: PPG MPP4100DGTJ; varnish: PPG TKU2000CCN-YF) to a PP substrate. The sample plate is taken out after excessive baking in an oven at 85° C. for 80-90 minutes. After complete cooling, the sample plate is again spray-coated with a background varnish, baked in an oven at 85° C. for 30 minutes, and then taken out for testing adhesion.

Adhesion is evaluated in accordance with GMW 14829-2012 Crosshatch using a 3M898 tape with cutting interval of 2 mm/3 mm and cutting number of 6*6.

Adhesion rating includes ratings “0-5”: rating “0” indicating no paint peeling; rating “1” indicating paint peeling area of less than 5%; rating “2” indicating paint peeling area of minimum 5% but no more than 15%; rating “3” indicating paint peeling area of minimum 15% but no more than 35%; rating “4” indicating paint peeling area of minimum 35% but no more than 65%; rating “5” indicating paint peeling area of greater than or equal to 65%.

Destruction test is conducted as follows: cross-cutting the paint surface with a NT knife, lifting the paint film at the cross point with the knifepoint to observe if the paint film could be lifted to evaluate recoating adhesion. If the paint film could not be completely lifted, it is evaluated as OK; if the paint film could be lifted, it is evaluated as NOK.

It can be seen from Table 4 that the paint film prepared by the invention Example's coating has superior results for adhesion test and destruction test over those prepared by Comparative examples 1-2.

TABLE 4
Recoating Adhesion Testing

| | Recoating Adhesion | Destruction Test |
|---|---|---|
| Example 1 | Rating 0 | OK |
| Comparative | Rating 5 | NOK |
| Example 1 | | |
| Comparative | Rating 2 | NOK |
| Example 2 | | |

4. Humidity Resistance Test

Sample treatment: a sample plate is prepared by applying a basecoat (YF-SGM9753(YT)) and matching primer and varnish (primer: PPG MPP4100DGTJ; varnish: PPG TKU2000CCN-YF) to a PP substrate. The sample plate is taken out after baking in an oven at 85° C. for 30 minutes. The sample plate is aged in an aging box at 60° C. for 48 hrs, and placed under laboratory conditions at a temperature of 22-26° C. and relative humidity of 30-70% for more than 24 hrs. Tests are conducted according to the following procedure.

The sample coated with the paint is flushed using standard deionized water, placed in a humidity chamber at a temperature of 40±3° C. and a humidity of 100% for 240 hrs, and then examined for appearance and adhesion at 1 hr after taking out (as described above in 3).

It can be seen from Table 5 that the paint film prepared by the invention Example's coating has superior humidity resistance over those prepared by Comparative examples 1-2.

TABLE 5
Humidity Resistance Testing

| | Blistering and appearance | Adhesion rating |
|---|---|---|
| Example 1 | No blistering, normal visual | 0 |
| | appearance | |
| Comparative | Partial blistering, severe loss of | 3 |
| Example 1 | gloss | |
| Comparative | Slight blistering, slight loss of | 1 |
| Example 2 | gloss | |

5. Weather Resistance Test

Sample treatment: a sample plate is prepared by applying a basecoat (YF-SGM9753(YT)) and matching primer and varnish (primer: PPG MPP4100DGTJ; varnish: PPG TKU2000CCN-YF) to a PP substrate. The sample plate is taken out after baking in an oven at 85° C. for 30 minutes. The sample plate is aged in an aging box at 60° C. for 48 hrs, and placed under laboratory conditions at a temperature of 22-26° C. and relative humidity of 30-70% for more than 24 hrs. Tests are conducted according to the following procedure.

An Atlas CI5000 xenon lamp aging box is used to conduct test according to SAE J2527 2004: Non-continuous illumination at 340 nm with irradiation energy of 0.55 W/m²/nm1, wherein the temperature and relative humidity are 38±2° C. and 95±5% under blackboard dark conditions, and 70±2° C. and 50±5% under lighting conditions, using distilled or deionized water containing no or less than 20 ppm silicon. Cycle manner comprises: spraying before and after darkness for 60 minutes, lighting for 40 minutes without spraying, spraying before lighting for 20 minutes, lighting for 60 minutes without spraying, with an experiment period of 2500 KJ/4500 KJ. Gloss, color, and adhesion are visually evaluated. Variation in gloss is measured using BYK Gardner 4430 and variation in color difference is measured using BYK mac II color difference meter.

Initial gloss G₀ before testing and gloss G₁ after testing are measured using BYK Gardner 4430 glossmeter, and gloss retention is equal to (1-(G₀-G₁)/G₀)*100%. Initial color difference E₀ before testing and gloss E₁ after testing are measured using BYK mac II color difference meter, and ΔE=(E₁-E₀)/E₀*100%.

It can be seen from the Table below that the paint film prepared by the invention Example's coating has superior properties over those prepared by Comparative examples 1-2.

TABLE 6
Light Fastness and Xenon Lamp Aging Testing Results

| | Gloss | | | Variation in color and |
|---|---|---|---|---|
| Product name | retention ≥85% | ΔE ≤3.0 | adhesion | appearance |
| Example 1 | 88.6% | 1.8 | Rating 0 | No significant variation in |
| | | | | color and gloss |
| Comparative | 81.7% | 7.9 | Rating 2 | significant variation in color |
| Example 1 | | | | and gloss |
| Comparative | 84.3% | 4.6 | Rating 1 | slight variation in color and |
| Example 2 | | | | gloss |

The paint film prepared by the invention Example's coating has been tested for various properties as described above. It can be clear from these testing results that the paint film prepared by the invention Example's coating composition exhibits excellent orange peel appearance and visual effect, good light fastness, recoatability resitance, humidity resistance, and weather resistance.

Although particular aspects of this invention have been explained and described above, it will be evident to those skilled in the art that numerous variations and modifications to the present invention may be made without departing from the scope and spirit of the present invention. Therefore, the appended claims are intended to encompass these variations and modifications falling within the present invention.

1. A coating composition comprising 10-20 wt % of a polyester resin, 2-8 wt % of an amino resin, and 0-6 wt % of an acrylic resin, based on the total weigh of the coating composition.

2. The coating composition of claim 1, wherein the polyester resin has a hydroxyl value from 50 to 100 mgKOH/g, an acid value from 0 to 5 mgKOH/g, and a weight average molecular weight (Mw) from 3000 to 5000.

3. The coating composition of claim 1, wherein the acrylic resin has a Tg from 40 to 50° C., a hydroxyl value from 10 to 40 mgKOH/g, and a weight average molecular weight (Mw) from 20000 to 30000.

4. The coating composition of claim 1, further comprising 20-40 wt % of a pigment, 30-50 wt % of a solvent, and 0-4wt % of an additive, based on the total weigh of the coating composition.

5. The coating composition of claim 4, wherein the pigment comprises titanium dioxide.

6. The coating composition of claim 4, wherein the solvent is selected from the group consisting of n-butanol, xylene, butyl acetate, ethylene glycol butyl ether acetate, acetone and methyl n-amyl ketone.

7. The coating composition of claim 4, wherein the additive comprises cellulose acetate butyrate, a leveling agent, and a resistivity regulator.

8. A coated substrate, comprising
(i) a substrate, and
(ii) a coating composition deposited on at least a portion of the substrate, the coating composition comprising 10-20 wt % of a polyester resin, 2-8 wt % of an amino resin, and 0-6 wt % of an acrylic resin, based on the total weigh of the coating composition.

9. The coated substrate of claim 8, wherein the substrate comprises polypropylene, polycarbonate, and acrylonitrile-butadiene-styrene copolymer (ABS) substrate.

10. The coated substrate of any one of claims 8-9, wherein the substrate comprises automotive bumper, spoiler, and door handle.
